(19) United States
(12) Patent Application Publication
(10) Pub. No.: US 2026/0118315 A1
(43) Pub. Date: Apr. 30, 2026

(54) SYSTEMS AND METHODS FOR ROBOTIC CAPILLARY MICROSAMPLING

(71) Applicant: UNIVERSITY OF MARYLAND, COLLEGE PARK, College Park, MD (US)

(72) Inventors: Peter Nemes, Silver Spring, MD (US); Dashuang Jia, College Park, MD (US)

(21) Appl. No.: 19/472,362

(22) PCT Filed: Apr. 5, 2024
(86) PCT No.: PCT/US2024/023354

§ 371 Date: Oct. 3, 2025

Related U.S. Application Data
(60) Provisional application No. 63/494,749, filed on Apr. 6, 2023.
(60) Provisional application No. 63/574,465, filed on Apr. 4, 2024.

(51) Int. Cl. G01N 27/447; G01N 30/24; G01N 35/10

(52) U.S. Cl. CPC G01N 27/44743; G01N 30/24; G01N 35/10; G01N 2035/1039

(57) ABSTRACT

A microsampling system includes a housing, a capillary fixed within a sealed internal environment defined by the housing, a robotic translation mechanism configured to support a sample holder and move the sample holder relative to the capillary in a plurality of directions, and a first port for connecting the sealed internal environment to a fluid source. A plurality of second ports may connect the sealed internal environment to a computing device, a voltage source, and/or a mass spectrometer ESI interface. A method of microsampling includes moving a sample holder within a sealed internal environment to operably position a capillary relative to a sample volume, pressurizing the sealed internal environment to inject a sample volume into the capillary, moving the sample holder to operably position the capillary relative to a BGE coupled to a voltage source, and applying electrical energy to separate the first sample volume via capillary electrophoresis.

### CROSS-REFERENCE TO RELATED APPLICATION

This application claims the benefit of and priority to U.S. Provisional Patent Application Nos. 63/494,749 (filed on April 6, 2023) and 63/574,465 (filed on April 4, 2024), the entire contents of each of which are hereby incorporated herein by reference.

### FIELD

The present disclosure relates to sampling systems and methods and, more specifically, to systems and methods for robotic capillary microsampling.

### BACKGROUND

Mass spectrometry is a common method for chemical analysis of a sample volume. Indeed, mass spectrometry is the technology of choice for the analysis of biomolecules. Typically, mass spectrometry involves depositing a relatively large sample volume into an autosampler vial, from which about 100 nL to about 20 μL of the sample volume is injected into a mass spectrometer for detection.

Prior to mass spectrometry detection, separation is often performed. Separation is important as it allows for reduction of chemical noise, spectral interferences, and ionization interferences. Separation also provides separation time as compound-dependent information that may be utilized for identification and/or structural elucidation of molecules. Thus, separation facilitates sensitive detection of the molecular composition of a sample volume, which is the main goal of most mass spectrometry measurements.

Liquid chromatography is an established technique for separating molecules prior to mass spectrometry detection. Capillary electrophoresis is another technique for separating molecules prior to mass spectrometry detection. Capillary electrophoresis may yield higher separation power and/or higher sensitivity than liquid chromatography.

However, while both capillary electrophoresis and liquid chromatography are effective separation techniques prior to mass spectrometry detection for relatively large sample volumes, present systems and methods employing either of these separation techniques prior to mass spectrometry detection are unable to achieve effective and efficient separation and subsequent mass spectrometry detection for samples that measure relatively small in volumes on the order of 100 nL to 1 μL, from which about 10 nL to about 20 nL of the sample volume is injected into the mass spectrometry system for detection.

### SUMMARY

The robotic capillary microsampling systems and methods of the present disclosure enable effective and efficient sampling and separation for subsequent mass spectrometry detection of relatively small sample volumes, e.g., on the order of 100 nL to 1 μL and from which about 10 nL to about 20 nL of the sample volume is sampled, separated, and injected into a mass spectrometry system for detection. The systems and methods of the present disclosure enable such sampling and separation in a fully automated and controllable manner. Further, the systems and methods of the present disclosure are not limited to use with relatively small sample volumes but are also capable of working with relatively large sample volumes, are ready for integration with commercial mass spectrometers (e.g., any mass spectrometer equipped with an electrospray ionization (ESI) interface), and enable increased sensitivity in mass spectrometry detection. These and other aspects and features of the present disclosure are detailed hereinbelow.

Provided in accordance with aspects of the present disclosure is a microsampling system including a housing configured to be sealed to define a sealed internal environment, a capillary disposed within the sealed internal environment in fixed position relative to the housing, and a robotic translation mechanism disposed within the sealed internal environment and configured to support and move the sample holder relative to the capillary in a plurality of directions. A first port defined through the housing may define a passthrough for connecting the sealed internal environment to an external fluid source.

In an aspect of the present disclosure, the first port defines the passthrough for connecting the external fluid source with the sealed internal environment to enable selective pressurization or depressurization of the sealed internal environment. In such aspects, an electro-pneumatic regulator may be coupled between the external fluid source (e.g., compressed and pressure-regulated nitrogen) and the first port and configured to apply a pressurization pulse of fluid to the sealed internal environment to inject the sample from the sample holder into the capillary.

In an aspect of the present disclosure, the robotic translation mechanism is a three-axis translation mechanism configured to move the sample holder relative to the capillary along three perpendicular axes.

One or more second ports may be provided where each second port of the plurality of second ports defines a passthrough for connecting the sealed internal environment to at least one of: an external computing device; an external voltage source; or an external electrospray ionization (ESI) interface of a mass spectrometer.

In an aspect of the present disclosure, a second port of the plurality of second ports defines the passthrough for connecting the robotic translation mechanism within the sealed internal environment to the external computing device to enable the external computing device to control the robotic translation mechanism.

In another aspect of the present disclosure, a second port of the plurality of second ports defines the passthrough for connecting a conductive vial (e.g., containing an electrophoresis background electrolyte) within the sealed internal environment to the external voltage source to enable application of electrical energy for electrophoresis.

In yet another aspect of the present disclosure, a second port of the plurality of second ports defines the passthrough for connecting the capillary within the sealed internal environment to the external ESI interface for output of a sample volume from the capillary to the mass spectrometer.

In still another aspect of the present disclosure, a second port of the plurality of second ports defines the passthrough for connecting at least a portion of the sample holder within the sealed internal environment to the external voltage source to enable application of electrical energy to the sample holder for electrokinetic injection of a sample from the sample holder into the capillary.

In still yet another aspect of the present disclosure, the system further includes a non-transitory computer-readable storage medium storing instructions that, when executed by at least one processor, cause the at least one processor to control the robotic translation mechanism disposed within the sealed internal environment to move the sample holder relative to the capillary.

In an aspect of the present disclosure, the at least one processor is further caused to control injection of a sample volume from the sample holder into the capillary at a first location of the sample holder and to control electrophoresis of the sample volume (e.g., sample plug) within the capillary at a second, different location of the sample holder.

In another aspect of the present disclosure, the system further includes a graphical user interface configured to at least one of display or enable selection of a location of a sample volume on the sample holder. In such aspects, the at least one processor is caused to control injection of the sample volume from the at least one of displayed or selected location.

A method of microsampling provided in accordance with the present disclosure includes moving a sample holder including at least a first sample volume within a sealed internal environment such that a capillary disposed within the sealed internal environment is operably positioned relative to the first sample volume, pressurizing the sealed internal environment to inject at least a portion of the first sample volume into the capillary, moving the sample holder such that the capillary, including the at least the portion of the first sample volume, is operably positioned relative to a background electrolyte electrically coupled to a voltage source, and applying electrical energy from the voltage source to separate the at least the portion of the first sample volume within the capillary via capillary electrophoresis.

In an aspect of the present disclosure, the method further includes outputting the at least the portion of the first sample volume to an electrospray ionization (ESI) interface of a mass spectrometer for mass spectrometry detection of the at least the portion of the first sample volume.

In another aspect of the present disclosure, the method further includes moving the sample holder such that the capillary is operably positioned relative to a rinsing station, and rinsing the capillary with a rinsing agent.

In still another aspect of the present disclosure, the sample holder further includes a second sample volume and the method further includes moving the sample holder such that the capillary is operably positioned relative to the second sample volume, pressurizing the sealed internal environment to inject at least a portion of the second sample volume into the capillary, moving the sample holder such that the capillary, including the at least the portion of the second sample volume, is operably positioned relative to the background electrolyte electrically coupled to the voltage source, and applying electrical energy from the voltage source to separate the at least the portion of the second sample volume within the capillary via capillary electrophoresis.

In yet another aspect of the present disclosure, moving the sample holder such that the capillary is operably positioned relative to the first sample volume, pressurizing the sealed internal environment, moving the sample holder such that the capillary is operably positioned relative to the background electrolyte, and applying electrical energy are automatically performed under control of a processor executing instructions stored on a non-transitory computer readable storage medium.

In still yet another aspect of the present disclosure, the method further includes loading the sample holder into the housing and sealing the housing to define the sealed internal environment. In aspects, loading and sealing are performed manually prior to automatically moving the sample holder such that the capillary is operably positioned relative to the first sample volume, pressurizing the sealed internal environment, the moving the sample holder such that the capillary is operably positioned relative to the background electrolyte, and applying electrical energy.

In another aspect of the present disclosure, the method further includes guiding at least one of the moving the sample holder such that the capillary is operably positioned relative to the first sample volume or the moving the sample holder such that the capillary is operably positioned relative to the background electrolyte using optical feedback provided by at least one camera.

In yet another aspect of the present disclosure, pressurizing the sealed internal environment includes applying a pressure pulse of fluid into the sealed internal environment.

In still another aspect of the present disclosure, the method further includes receiving an input of a selection of a location of the first sample volume on the sample holder. In such aspects, the moving the sample holder such that the capillary is operably positioned relative to the first sample volume includes moving the sample holder such that the capillary is operably positioned at the selected location of the first sample volume.

A non-transitory computer-readable storage medium provided in accordance with the present disclosure stores instructions that, when executed by at least one processor, cause the at least one processor to control movement of a sample holder including at least a first sample volume within a sealed internal environment such that a capillary disposed within the sealed internal environment is operably positioned relative to the first sample volume, pressurization of the sealed internal environment to inject at least a portion of the first sample volume into the capillary, movement of the sample holder such that the capillary, including the at least the portion of the first sample volume, is operably positioned relative to a background electrolyte electrically coupled to a voltage source, and application of electrical energy from the voltage source to separate the at least the portion of the first sample volume within the capillary via capillary electrophoresis.

### BRIEF DESCRIPTION OF THE DRAWINGS

Various aspects and features of the present disclosure are described hereinbelow with reference to the drawings wherein:

FIG. 1 is a schematic illustration of a robotic capillary microsampling system provided in accordance with the present disclosure;

FIG. 2 is a perspective view of a housing of the robotic capillary microsampling system of FIG. 1;

FIG. 3 is a schematic illustration of a robotic three-axis translation mechanism of the robotic capillary microsampling system of FIG. 1;

FIG. 4 is a top, perspective view of a sample holder provided in accordance with the present disclosure and configured for use with the robotic capillary microsampling system of FIG. 1;

FIG. 5A is a sample (conductive) microvial configured for use with the sample holder of FIG. 4, including a capillary disposed therein for access a sample within the microvial;

FIG. 5B is another sample microvial configured for use with the sample holder of FIG. 4;

FIG. 6 is a schematic illustration of camera-aided sample acquisition using the robotic capillary microsampling system of FIG. 1;

FIGS. 7A and 7B are graphical user interfaces (GUIs) for controlling and monitoring the robotic capillary microsampling system of FIG. 1;

FIG. 8 is a flow diagram illustrating a method of sampling, separation, and output for mass spectrometry detection in accordance with the present disclosure,

FIG. 9 is a microscope image of a portion of a capillary including a series of sample cells disposed therein after injection using the robotic capillary microsampling system of FIG. 1;

FIGS. 10A-10C are tables of results of various microsampling tests using the robotic capillary microsampling system of FIG. 1; and

FIGS. 11A-11C are graphs illustrating results of sampling, separation, and mass spectrometry detection in accordance with the present disclosure for model peptides, complex protein digests, and multiple sample plugs, respectively.

### DETAILED DESCRIPTION

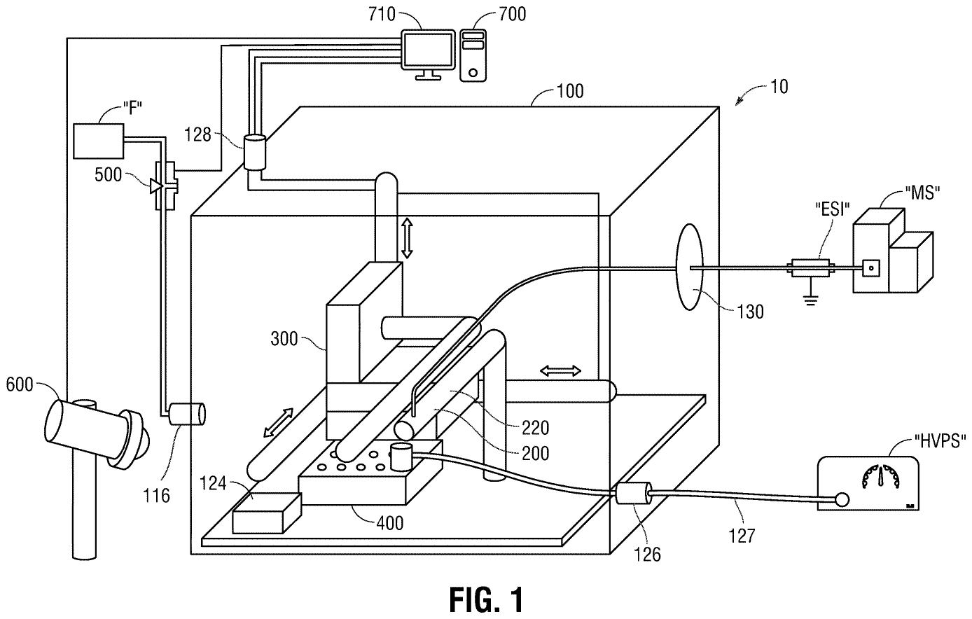

Turning to FIG. 1, a robotic microsampling capillary system provided in accordance with the present disclosure is shown generally identified by reference numeral 10. System 10 includes: a housing 100 configured to establish a sealed internal environment to facilitate sampling; a capillary assembly 200 configured to receive an injected sample volume, enable separation of the sample volume, and transmit the sample volume to a mass spectrometer “MS,” a robotic three-axis translation mechanism 300 configured to support a sample holder 400 and maneuver the sample holder 400 relative to the capillary assembly 200 to facilitate sampling and separation of a sample volume; a pressure control assembly 500 configured to control the pressurization and depressurization of the sealed internal environment within housing 100; and, in some aspects, one or more microscope cameras 600 configured to enable optical inspection of the sealed internal environment within housing 100 to facilitate optical-based feedback. System 10 may further include, or be connectable to, a computing device 700 (running software suitable for controlling system 10) configured to enable control and, in aspects, automated operation of system 10 for sampling, separation, and output of a sample volume to a mass spectrometer “MS” connected to system 10, e.g., via an electrospray ionization (ESI) interface “ESI” of the mass spectrometer “MS.” A fluid source “F” and a high-voltage power supply “HVPS” are also connected to system 10 to enable pressurization and depressurization of the sealed internal environment within housing 100 and to enable the supply of electrical energy, respectively. These components of system 10, along with other aspects and features of the present disclosure, are described in greater detail hereinbelow.

In aspects, housing 100 of system 10 is mounted on a height-adjustable support (not shown), e.g., a cart, to enable operable positioning of housing 100 relative to mass spectrometer “MS” to facilitate connection between and output of a sample volume from system 10 to ESI interface “ESI” of mass spectrometer “MS.”

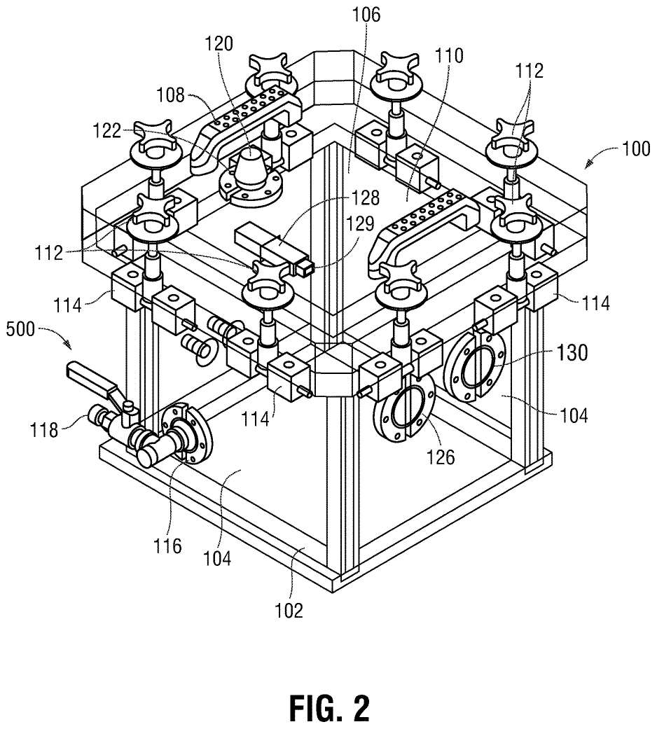

With reference to FIG. 2, housing 100 includes a base 102, four (4) sidewalls 104, and a lid 106 configured to cooperate to define a hermetically sealed internal environment. At least sidewalls 104 and, in aspects, lid 106 and/or base 102, are formed from an optically transparent material to enable optical inspection into the sealed internal environment within housing 100.

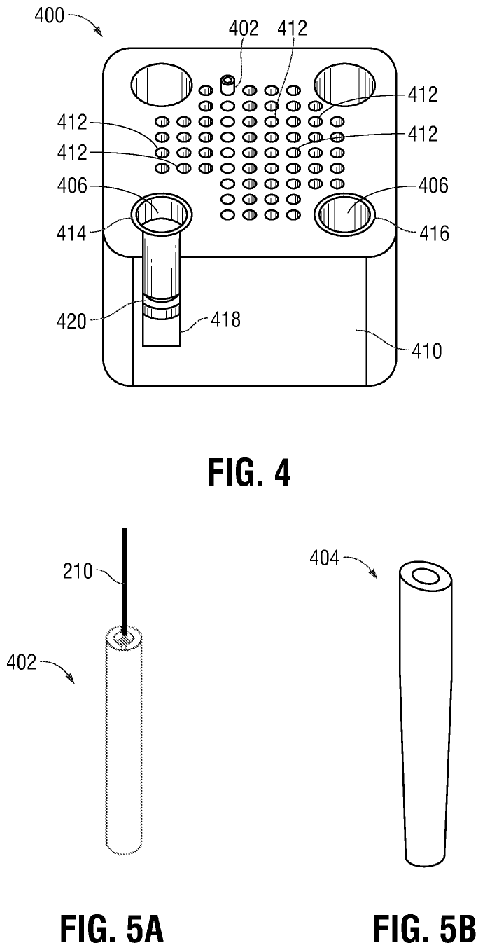

Lid 106 includes one or more handles 108 configured to facilitate opening and closing of lid 106 and a gasket 110 or other suitable sealing interface configured to hermetically seal the internal environment within housing 100 when lid 106 is engaged in the closed position. One or more screw clamps 112 or other suitable engagement mechanisms of lid 106 are configured to engaged lid 106 with sidewalls 104 in the closed position of lid 106 to establish the hermetic seal of the internal environment of housing 100. One or more hinges 114 associated with corresponding screw clamps 112 or separate therefrom may also be provided to enable hinged, or pivotable, movement of lid 106 between the closed and open positions. With lid 106 disposed in the open position, for example, sample holder 400 (FIGS. 1 and 4) may be removed to enable the exchange of sample vials supported by sample holder 400 (FIGS. 1 and 4) externally of housing 100, sample holder 400 (FIGS. 1 and 4) may be replaced with another sample holder 400 (FIGS. 1 and 4), and/or sample vials may be loaded into or removed from sample holder 400 (FIGS. 1 and 4) within housing 100. Once lid 106 is moved to the closed position and engaged, the hermetic seal of the internal environment of housing 100 is established.

Continuing with reference to FIG. 2, housing 100 defines a plurality of ports defined therethrough to enable the passage of components and/or matter to and from the hermetically sealed internal environment within housing 100 without compromising the hermetic seal. Although the various ports of housing 100 are illustrated and described herein at particular locations, e.g., through side walls 104 or lid 106, it is contemplated that the various ports of housing 100 may be disposed at any suitable location relative to housing 100. Further, although example ports are illustrated and described herein, other suitable alternative or additional ports are also contemplated.

With additional reference to FIG. 1, housing 100 includes a fluid port 116 configured to support an electro-pneumatic regulator 118 (functioning as or as part of pressure control assembly 500) that is coupled to the fluid source “F,” e.g., air or nitrogen gas (N₂), and to the external environment to enable the controlled pressurization of the hermetically sealed internal environment within housing 100, e.g., via inflow of fluid from the fluid source “F” through fluid port 116, and the controlled depressurization of the hermetically sealed internal environment within housing 100, e.g., via outflow of fluid from the hermetically sealed internal environment within housing 100 through fluid port 116. A safety port 120 may support a pressure safety valve 122 configured to inhibit over-pressurization of the hermetically sealed internal environment within housing 100. In aspects, a pressure sensor 124 (FIG. 1) is disposed within housing 100 and configured to monitor the pressure within the hermetically sealed internal environment within housing 100, e.g., to enable feedback-based pressure control.

Housing 100 further includes one or more feedthrough ports 126, 128, 130 configured to enable connection of components within housing 100 with components external of housing 100. For example, feedthrough port 126 enables passage of electrical cabling 127 through housing 100 to couple high-voltage power supply “HVPS” and one or more vials of sample holder 400 and/or sample holder 400 itself to enable capillary electrophoresis and/or electrokinetic injection, as detailed below. Feedthrough port 128 enables electrical connection of robotic three-axis translation mechanism 300 and, in aspects where provided, pressure sensor 124, with computing device 700 and a power source (not explicitly shown), although it is also contemplated that computing device 700 may provide the power for robotic three-axis translation mechanism 300 and/or pressure sensor 124. In aspects, feedthrough port 128 supports a USB connector 129 to establish the above-noted electrical connections; alternatively or additionally, electrical cabling (not explicitly shown) extending through feedthrough port 128 is configured to establish the above-noted electrical connections. Feedthrough port 130 enables connection of capillary assembly 200 with the ESI interface “ESI” of the mass spectrometer “MS.”

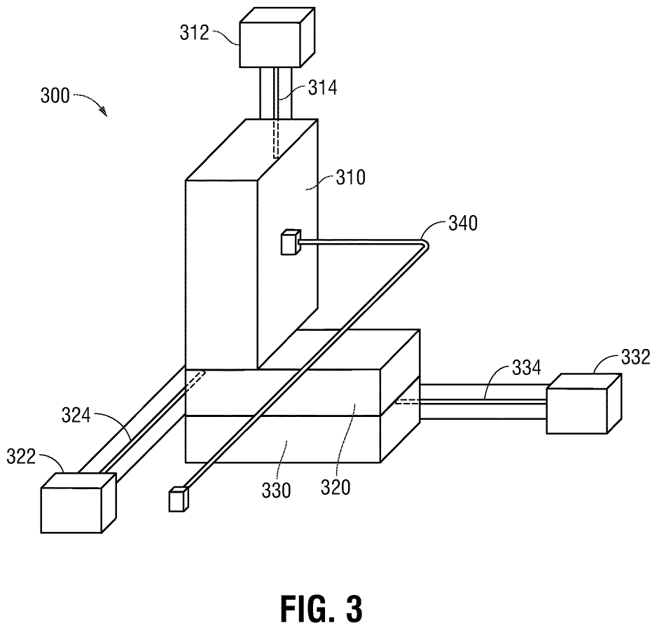

Referring to FIG. 3, in conjunction with FIG. 1, robotic three-axis translation mechanism 300 is disposed within housing 100 and configured to enable movement of sample holder 400 relative to capillary assembly 200 in three axes of motion, e.g., an X-axis, Y-axis, and Z-axis of motion. Robotic three-axis translation mechanism 300 includes a first translation stage 310, a second translation stage 320, and a third translation stage 330. Robotic three-axis translation mechanism 300 further includes a support arm 340 mounted to first translation stage 310 and configured to support sample holder 400, although it is also contemplated that sample holder 400 may be supported directly by first translation stage 310 or in any other suitable manner. First translation stage 310 is driven by a first motor 312 and configured to move along a first track 314 in a first axis of motion, e.g., the Z-axis of motion, relative to both second and third translation stages 320, 330 and housing 100. Second translation stage 320 is driven by a second motor 322 and configured to move along a second track 324 in a second axis of motion, e.g., the Y-axis of motion, relative to third translation stage 330 and housing 100. Second translation stage 320 supports first translation stage 310 such that movement of second translation stage 320 relative to third translation stage 330 likewise moves first translation stage 310 relative to third translation stage 330. Third translation stage 330 is driven by a third motor 332 and configured to move along a third track 334 in a third axis of motion, e.g., the X-axis of motion, relative to housing 100. Third translation stage 330 supports first and second translation stages 310, 320 such that movement of third translation stage 330 relative to third translation stage 330 likewise moves first and second translation stages 310, 320 relative to housing 100. Thus, via selective movement of first, second, and/or second translation stages 310, 320, 330, sample holder 400 (supported by support arm 340, which is engaged with first translation stage 310) is capable of being moved to any position within a three-dimensional volume defined within housing 100. Other suitable robotic mechanisms for three-axis translation are also contemplated.

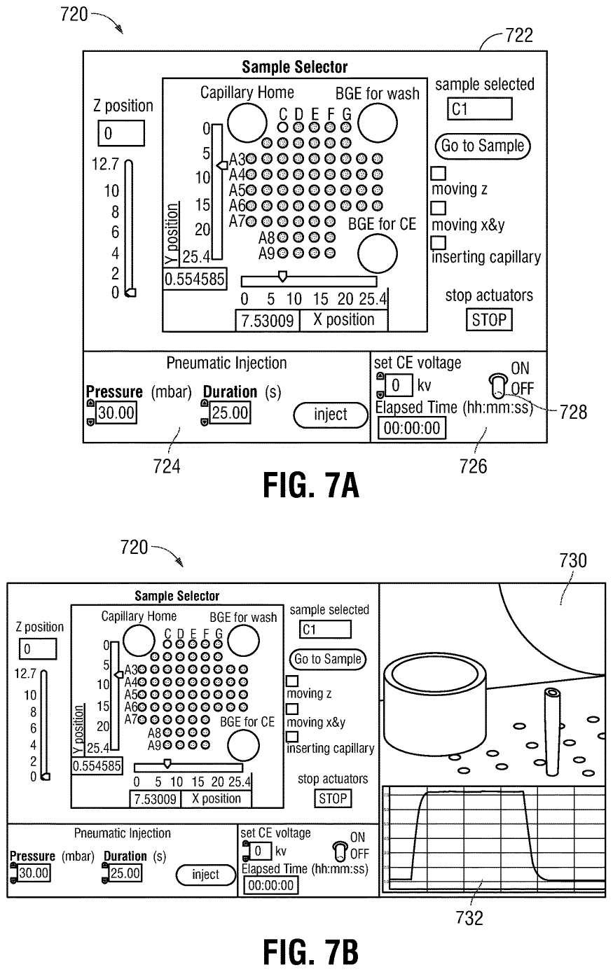

Turning back to FIG. 1, capillary assembly 200 is fixed within and relative to housing 100 such that the above-detailed robotic three-axis translation mechanism 300 is capable of moving sample holder 400 relative to capillary assembly 200 to position capillary assembly 200 for sampling, separation, and output of a sample volume from a sample (e.g., for mass spectrometry detection), cleaning capillary assembly 200, and repeating the above a plurality of times to enable automated sampling, separation, and output of a plurality of sample volumes (e.g., for mass spectrometry detection). Capillary assembly 200 includes a capillary 210 (FIG. 6) and a capillary support 220 configured to fixedly mount capillary 210 (FIG. 6) thereon and disposed in fixed position within and relative to housing 100. As noted above, capillary 210 (FIG. 6) is configured to connected with the ESI interface “ESI” of the mass spectrometer “MS” via feedthrough port 130 of housing 100 to enable the output of a sample volume from capillary 210 to the mass spectrometer “MS” for mass spectrometry detection. Capillary 210 (FIG. 6) may be formed from fused silica or other suitable materials. In aspects, capillary 210 (FIG. 6) is customized such as, for example, by pulling or beveling capillary 210 (FIG. 6) to define a finer tip diameter, although other configurations are also contemplated.

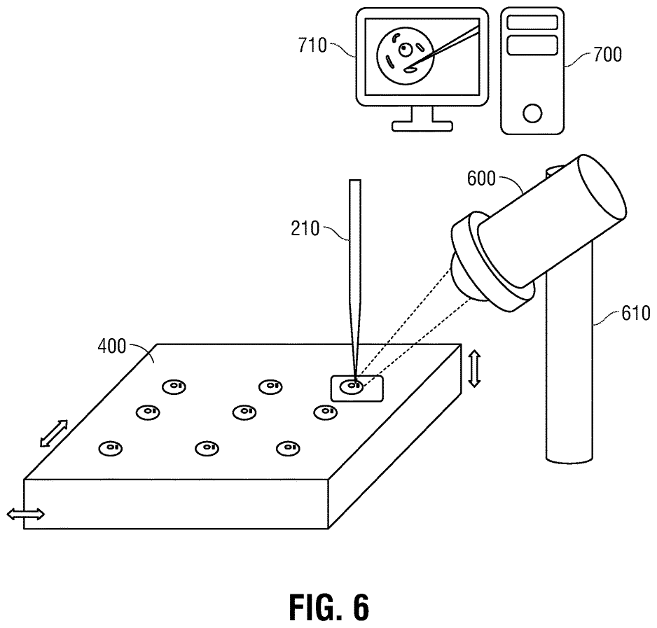

With reference to FIG. 4, sample holder 400 provided in accordance with the present disclosure is shown. Sample holder 400 is configured to hold a plurality of sample vials, e.g., microvials 402, 404 (FIGS. 5A and 5B, respectively), and/or a plurality of samples directly (e.g., without a vial). Although sample holder 400 is detailed herein, various other sample holders and/or sample vials are capable of being used with system 10 such as, for example, Eppendorf tubes, well plates, custom or commercial microvials, nanoPOTS, etc.

Sample holder 400 includes a substrate 410 defining an array of sample vial wells 412 each configured to hold a microvial 402, 404 (FIGS. 5A and 5B, respectively). In aspects, the array of sample vial wells 412 defines a matrix having a plurality of rows and a plurality of columns, although, as shown, portions of the matrix may be removed such that not all rows and/or not all columns have an equal number of sample vial wells 412. Sixty-one (61) sample vial wells 412 are shown; however, greater or fewer sample vial wells 412 are also contemplated.

Substrate 410 further defines one or more background electrolyte (BGE) vial wells 414, 416 each configured to hold a BGE vial 406. For example, in aspects, a first BGE vial well 414 configured to support a first BGE vial 406 is utilized for capillary electrophoresis while a second BGE vial well 416 configured to support a second BGE vial 406 including BGE or other suitable rinsing agent for rinsing or cleaning capillary 210 (FIG. 6) in preparation for subsequent sample runs. Substrate 410, in aspects, is formed at least partially from an insulative material such as, for example, chlorinated polyvinyl chloride (CPVC), other suitable thermoplastic, or other suitable material.

Substrate 410 may further include one or more access slots 418 each disposed in communication with one of the BGE via wells 414 to provide access to a connection terminal 420 of a conductive BGE vial 406 disposed within that BGE vial well 414 or to a conductive portion of the BGE vial well 414 in contact with the conductive BGE vial 406. Connection terminal 420 enables electrical connection of the high voltage power supply “HVPS” (FIG. 1) to the BGE vial 406 (which is formed from a conductive material) via an electrical lead (not explicitly shown) disposed within electrical cable 127 (FIG. 1) to enable electrification of the BGE vial 406 for capillary electrophoresis of a sample volume disposed within a capillary 210 (FIG. 6) in communication with BGE vial 406, as detailed below. In aspects, the high voltage power supply “HVPS” (FIG. 1) is further configured to connect to a conductive microvial 402 or a conductive portion of substrate 410 in contact with conductive microvial 402 to enable electrokinetic injection of a sample volume from the microvial 402 into capillary 210 (FIG. 6) when capillary 210 (FIG. 6) is disposed in contact with the sample within microvial 402.

In aspects, sample holder 400 is configured to be compatible for use with one or more other pieces of other laboratory equipment such as, for example, microscopes, spectrophotometers, fluorescent activated cell sorters, etc., thus enabling transfer between system 10 and other laboratory equipment without requiring removal or replacement of the samples.

Referring to FIG. 5A, microvial 402 provided in accordance with the present disclosure is formed from a conductive material, e.g., stainless steel, and defines a substantially cylindrical configuration. Another microvial 404 provided in accordance with the present disclosure is shown in FIG. 5B. Microvial 404 is formed from an insulative material and defines a substantially frustoconical configuration. Other suitable microvial configurations are also contemplated.

Turning to FIG. 6 in conjunction with FIG. 1, in aspects, as noted above, one or more microscope cameras 600 may be provided to enable optical inspection of the injection of a sample volume from sample holder 400 into capillary 210. One or more of the microscope cameras 600 may be disposed externally of housing 100, imaging the sealed internal environment within housing 100 through the transparent sidewalls 104 of housing 100. Alternatively or additionally, one or more of the microscope cameras 600 may be disposed within housing 100. Regardless of the positioning of the one or more microscope cameras 600, each of the microscope cameras 600 may be mounted on a support 610 in a fixed manner or in a manner enabling movement, e.g., panning, tilting, sliding, etc., of the microscope camera 600. Regardless of the particular configuration the one or more microscope cameras 600 enable optical inspection of the position of capillary 210 and the injection of a sample volume from sample holder 400 into capillary 210, thus enabling a user to monitor and/or confirm operation, e.g., by viewing a display 710 associated with computing device 700 displaying a video feed from the one or more microscope cameras 600, and/or enabling optical feedback-based control, e.g., optical guidance of robotic three-axis translation mechanism 300 to position sample holder 400 relative to capillary 210, to initiate sample, to reposition holder 400 for separation, to initiate separation, etc.

Returning to FIG. 1, computing device 700 is connected, via wired or wireless connection, to each of robotic three-axis translation mechanism 300, pressure control assembly 500 (e.g., electro-pneumatic regulator 118), microscope camera(s) 600, mass spectrometer “MS,” and high-voltage power supply “HVPS” to enable fully controlled, and automated, sampling, separation, and output for mass spectrometry detection of a sample volume from a sample or a series of sample volumes from one or more samples. Suitable software for performing this functionality is stored in a memory of or accessible by computing device 700 to enable one or more processors of computing device 700 to perform the above-detailed functionality.

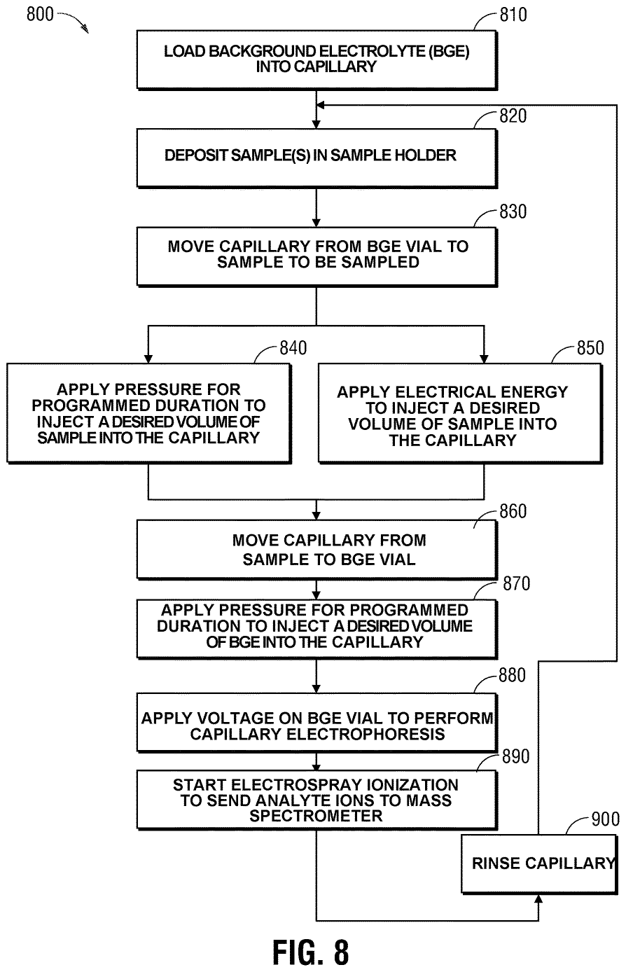

With additional reference to FIG. 7A, an exemplary graphical user interface (GUI) 720, e.g., of display 710 of computing device 700 (see FIG. 1), is generated by the software of system 10 to enable programming, controlling, and/or monitoring of system 10 in use. GUI 720 includes a sample selector panel 722 which displays a representation of the array of sample vial wells 412 of sample holder 400 (see FIG. 4) as well as representations of the BGE vial wells 414 of sample holder 400 (see FIG. 4). The position of capillary 210 (FIG. 6) relative to the sample holder 400 in each of the X-axis, Y-axis, and Z-axis direction of motion is also illustrated. From sample selector panel 722, the operator may select, e.g., via a touch-screen interface or using another input device such as a mouse, a sample for selection, which is then indicated on sample selector panel 722. Further, the operator may activate robotic three-axis translation mechanism 300, e.g., via the “Go to sample” button of sample selector panel 722, to move sample holder 400 such that the selected sample is operably positioned relative to capillary 210 (FIG. 6), and may monitor the X-axis, Y-axis, and Z-axis positions and movements of sample holder 400. In such aspects, system 10 automatically determines the requisite movements in the X-axis, Y-axis, and Z-axis directions necessary to move the appropriate portion of sample holder 400 into operable position relative to capillary 210 (FIG. 6), thus enabling automated operation. A “STOP” button is provided on sample selector panel 722 to stop the movement of sample holder 400.

GUI 720 also includes a pneumatic injection panel 724 enabling the setting of the pressure and duration of the pressurization of the hermetically sealed internal environment within housing 100 to inject a sample volume from the sample into capillary 210 (FIG. 6). In aspects where electrokinetic injection is utilized, pneumatic injection panel 724 may be replaced with an electrokinetic injection panel enabling the setting of one or more electrical parameters (e.g., power, voltage, current, etc.) and the duration of the electrical energy provided to achieve electrokinetic injection. In aspects, the fields in pneumatic injection panel 724 are pre-filled based on default settings, other operator-inputs, etc. ; however, in such aspects, adjustment of these fields may still be made by the operator as needed. Pre-filling the fields of pneumatic injection panel 724 enables movement of sample holder 400 into position and injection of the sample volume into capillary 210 (FIG. 1) from a single click or other actuation instruction from the operator.

A capillary electrophoresis panel 726 of GUI 720 enables setting of the voltage (and/or other electrical parameter(s)) and duration of the electrical energy application to perform capillary electrophoresis. Similarly as above, the fields in capillary electrophoresis panel 726 may be pre-filled based on default settings, other operator-inputs, etc., although subsequent adjustment of these fields may be performed by the operator as needed. Pre-filling the fields of capillary electrophoresis panel 726 enables movement of sample holder 400 into position, injection of the sample volume into capillary 210 (FIG. 6), and separation of the sample for output to the mass spectrometer “MS” from a single click or other actuation instruction from the operator. Capillary electrophoresis panel 726 may also include a toggle 728 configured to turn ON and OFF the supply of electrical energy for capillary electrophoresis.

Referring still to FIGS. 1 and 7A, as detailed above, the software running on computing device 700 enables the movement of sample holder 400 into position, injection of the sample volume into capillary 210 (FIG. 6), and separation of the sample for output to the mass spectrometer “MS” in a fully automated manner from a single click or other actuation instruction from the operator. Further, in addition to automating a single sample run, as detailed above, system 10 may be configured to operate a series of sample runs. For example, using GUI 720, the operator may select a sequence of sample vial wells 412 (FIG. 4) or, where no sequence is selected, computing device 700 may follow a default sequence, such that a plurality of sample runs may be performed sequentially, until sampling, separation, and mass spectrometry detection is performed on each sample of the plurality of samples.

With reference to FIG. 7B, in aspects, GUI 720 may further include a video feed panel 730 displaying the video feed from the one or more microscope cameras 600. GUI 720 may additionally or alternatively include a electrical signal panel 732 illustrating a plot of electrical energy output, e.g., voltage as a function of time, to enable visualization of the capillary electrophoresis process.

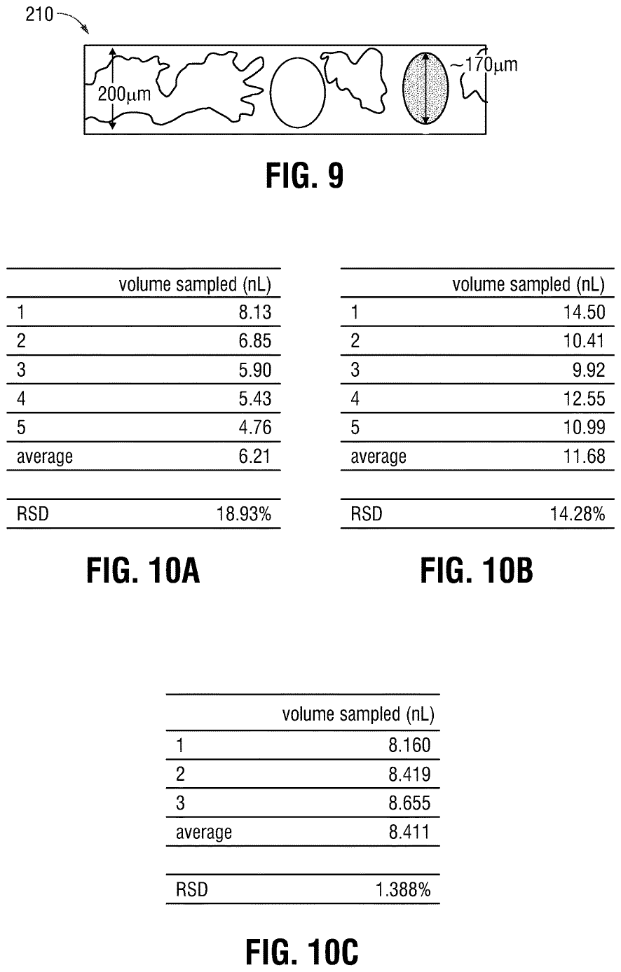

Turning to FIG. 8, in conjunction with FIGS. 1-4 and 6, a method 800 performed via system 10, e.g., in a fully controlled and automated manner, for sampling, separation, and output of a sample volume for mass spectrometry analysis is detailed. Initially, BGE vials 406 including background electrolyte (BGE) are loaded into the one or more BGE vial wells 414, 416 of sample holder 400, which is operably supported by support arm 340 of robotic three-axis translation mechanism 300 within housing 100. Thereafter, as indicated at 810, BGE is loaded into capillary 210, e.g., by operating robotic three-axis translation mechanism 300 to move sample holder 400 to a BGE vial 406 to enable BGE to be loaded from one of the BGE vials 406 into capillary 210.

Before, after, or concurrently with 810, one or more samples, e.g., each within a microvial 402, are deposited into or on sample holder 400, as indicated at 820. Electrical connections, e.g., between high voltage power supply “HVPS” and one of the BGE vials 406 are also established. Thereafter, lid 106 is replaced to enclose and hermetically seal housing 100.

At 830, robotic three-axis translation mechanism 300 moves sample holder 400 such that capillary 210 moved from the BGE vial 406 to the first sample to be sampled, e.g., such that the inlet of the capillary 210 is disposed in contact with the first sample for detection within the microvial 402 containing the first sample.

Next, as indicated at 840, a desired volume of the first sample is injected from microvial 402 into capillary 210 via a controlled application of a programmed pressure for a programmed duration. Alternatively, as indicated at 850, electrical energy may be applied to inject a desired volume of the first sample from microvial 402 into capillary 210 via electrokinetic injection. Once the desired volume of the first sample is injected into capillary 210, robotic three-axis translation mechanism 300 moves sample holder 400 such that capillary 210 is moved to a BGE vial 406, e.g., at the first or capillary electrophoresis BGE vial 406, as indicated at 860.

At 870, with capillary 210 positioned at a BGE vial 406, e.g., with the inlet of capillary 210 in contact with the BGE within the first BGE vial 406, the controlled application of a programmed pressure for a programmed duration it utilized to inject a desired volume of the BGE into the capillary 210. However, 870 is optional in that, in other aspects, 870 is omitted and a BGE volume, e.g., plug, is not injected into the capillary 210 at 870. Thereafter, as indicated at 880, electrical energy, e.g., a DC voltage, is applied to perform electrophoresis on the first sample volume within the capillary 210.

Once electrophoresis is complete, the analyte ions of the first sample volume are output to the ESI interface “ESI” of the mass spectrometer “MS,” e.g., by starting electrospray ionization to send the analyte ions to the mass spectrometer “MS,” as indicated at 890, to enable mass spectrometry detection, e.g., capillary electrophoresis mass spectrometry (CE-MS). Mass spectrometry detection involves starting the electrospray ionization source, starting mass spectrometer data acquisition. To finish mass spectrometry detection, mass spectrometer data acquisition is stopped, the power source is switched off, and the electrospray ionization source is switched off.

If further samples are to be tested, method 800 proceeds to 900, wherein robotic three-axis translation mechanism 300 moves sample holder 400 to, for example, the second or rinsing/cleaning BGE vial 406 for rinsing and, in aspects, re-loading BGE into capillary 210, before method 800 returns to 820 to repeat 820-890 for each subsequent sample to be tested, with a rinsing/pre-filling operation, as indicated at 900, being performed between each sample run.

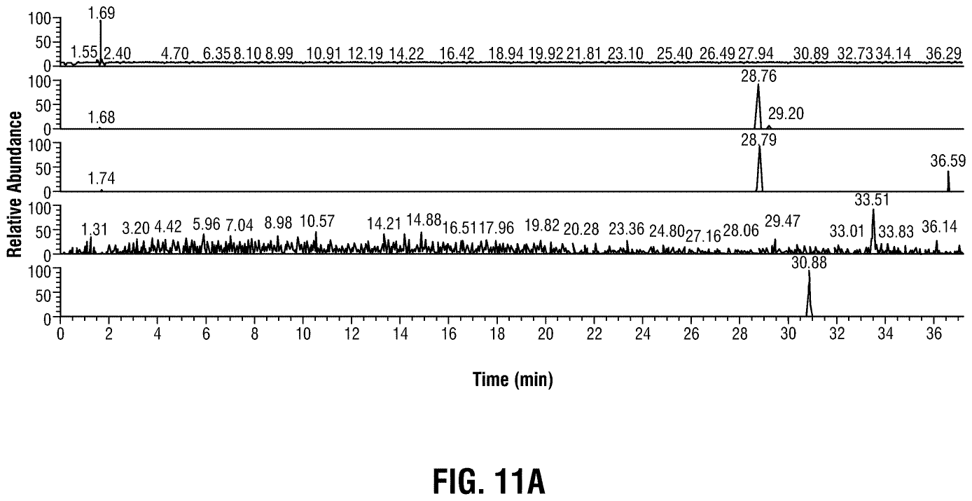

Turning to FIG. 9, in conjunction with FIGS. 1-4 and 6, system 10, in precisely controlling the location of sample holder 400 relative to capillary 210 and the pressurization of the interior environment within housing 100, and by providing an appropriate capillary 210, enables the movement sorting, manipulation, and ultimately, injection of individual cells into capillary 210. More specifically, where the sample includes a media containing cells, capillary 210 may be positioned within the media and, thereafter, a pressurization pulse may be applied to inject the cell or cells into capillary 210 such that the injected cells formed a series of individual cells each separated by media plug, as shown in FIG. 9, wherein capillary 210 defines an internal diameter of about 200 μm and each cell defines a diameter of about 170 μm. The cells collected in capillary 210 can be sorted into individual vials for single-cell analysis or may be output to the ESI interface “ESI” to be sprayed from the ESI interfaced “ESI” through the mass spectrometer “MS”for high-throughput analysis.

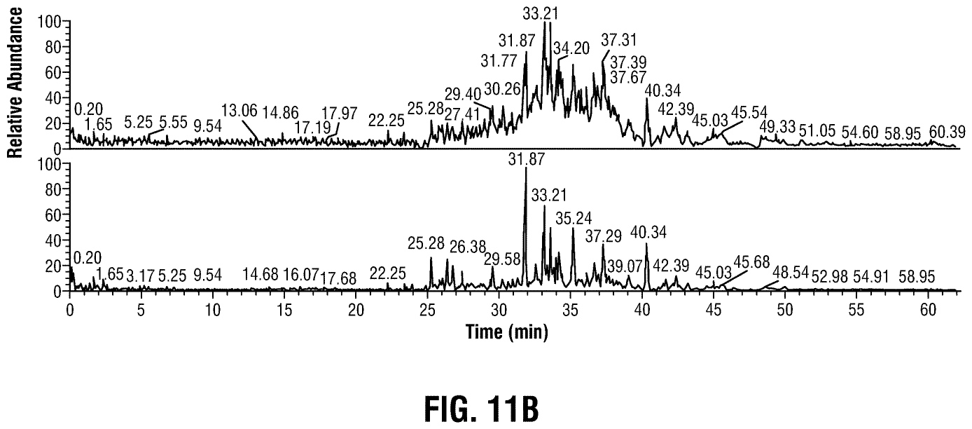

With reference to FIGS. 10A-10C, in conjunction with FIG. 1, the configuration of system 10, wherein housing 100 defines a hermetically sealed internal environment and wherein the pressure within housing 100, including the magnitude and duration of the pressurization pulse applied to the interior of housing 100, is controlled to enable accurate injection of a microsample volume into capillary 210 (FIG. 6). FIGS. 10A and 10B illustrate initial test results using an initial prototype of system 10, wherein water and an acetonitrile/water mixture (of 75% acetonitrile and 25% water) were used as the sample under test, respectively, and wherein injection was performed at a pressure of 30 mbar for 30 seconds. As shown in FIGS. 10A and 10B, relatively small volumes of sample averaging 6.21 nL and 11.68 nL, respectively, were able to be sampled with relative standard deviation values (RSD) of 18.93% and 14.28%, respectively. Further testing results using a further prototype of system 10 are shown in FIG. 10C, wherein injection of water was performed at a pressure of 30 mbar for 30 seconds and wherein a relatively small volume of sample averaging 8.41 nL was sampled with an RSD of 1.388%. Thus, system 10 enables accurate sampling of microsample volumes within or below a range of about 10 nL to about 20 nL from overall sample volume within or below a range of about 250 nL to about 1 μL. Further, dilution is unnecessary, thus enabling high sensitivity during subsequent mass spectrometry detection.

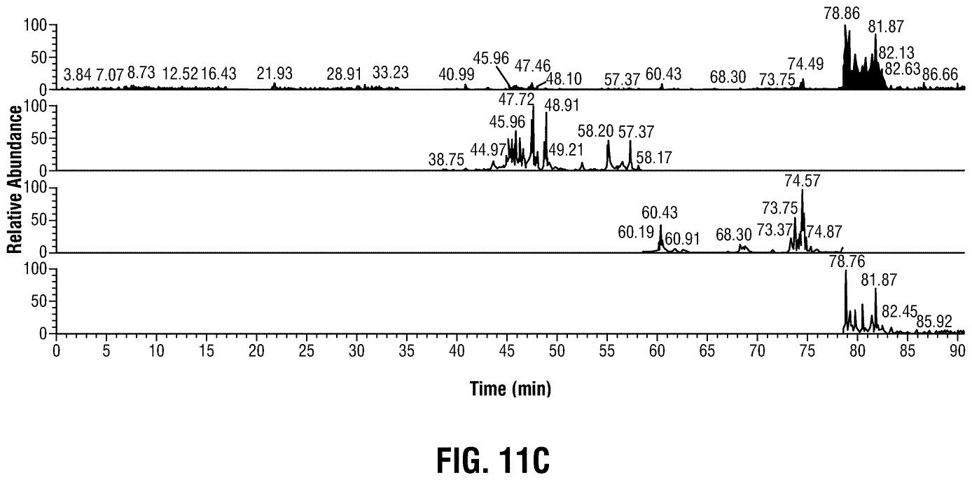

FIGS. 11A-11C represent graphs of mass spectrometry detection of various different samples obtained, separated, and output to the mass spectrometer “MS” using system 10 (see FIG. 1). More specifically, FIG. 11A illustrates mass spectrometer detection results of model peptides separated from a mixture of 10 nM angiotensin peptide standards, wherein the peptides were separated and detected using ESI mass spectrometry with peaks measuring ˜12 s of width; FIG. 11B illustrates mass spectrometer detection results of complex protein digests, wherein 32 nL (containing 32 ng) from 500 nL of a 1/μL Pierce™ HeLa Protein Digest Standard was loaded and wherein system 10 enabled detection of 1,253 different proteins using an ESI-high-resolution mass spectrometry (HRMS) mass spectrometer “MS” (which may be utilized in accordance with aspects of the present disclosure); and FIG. 11C illustrates results of high-throughput mass spectrometry detection of multiple sample plugs.

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The aspects described with reference to the attached drawings are presented only to demonstrate certain examples of the disclosure. Other elements, steps, methods, and techniques that are insubstantially different from those described above and/or in the appended claims are also intended to be within the scope of the present disclosure.

1. A microsampling system, comprising:
a housing configured to be sealed to define a sealed internal environment;
a capillary disposed within the sealed internal environment in fixed position relative to the housing;
a robotic translation mechanism disposed within the sealed internal environment and configured to support a sample holder, the robotic translation mechanism configured to move the sample holder relative to the capillary in a plurality of directions; and
a first port defined through the housing and defining a passthrough for connecting the sealed internal environment to an external fluid source to enable selective pressurization or depressurization of the sealed internal environment.

2. The microsampling system according to claim 1, further comprising an electro-pneumatic regulator coupled between the external fluid source and the first port and configured to apply a pressurization pulse of fluid to the sealed internal environment to inject a sample volume from the sample holder into the capillary.

3. The microsampling system according to claim 1, further comprising a plurality of second ports defined through the housing, each second port of the plurality of second ports defining a passthrough for connecting the sealed internal environment to at least one of: an external computing device; an external voltage source; or an external electrospray ionization (ESI) interface of a mass spectrometer; an external voltage source; or an external electrospray ionization (ESI) interface of a mass spectrometer.

4. The microsampling system according to claim 3, wherein a second port of the plurality of second ports defines the passthrough for connecting the robotic translation mechanism within the sealed internal environment to the external computing device to enable the external computing device to control the robotic translation mechanism.

5. The microsampling system according to claim 3, wherein a second port of the plurality of second ports defines the passthrough for connecting a conductive vial within the sealed internal environment to the external voltage source to enable application of electrical energy for electrophoresis.

6. The microsampling system according to claim 3, wherein a second port of the plurality of second ports defines the passthrough for connecting the capillary within the sealed internal environment to the external ESI interface for output of a sample volume from the capillary to the mass spectrometer.

7. The microsampling system according to claim 3, wherein a second port of the plurality of second ports defines the passthrough for connecting at least a portion of the sample holder within the sealed internal environment to the external voltage source to enable application of electrical energy to the at least a portion of the sample holder for electrokinetic injection of a sample volume from the sample holder into the capillary.

8. The microsampling system according to claim 1, further comprising a non-transitory computer-readable storage medium storing instructions that, when executed by at least one processor, cause the at least one processor to control the robotic translation mechanism disposed within the sealed internal environment to move the sample holder relative to the capillary.

9. The microsampling system according to claim 8, wherein the at least one processor is further caused to control injection of a sample volume from the sample holder into the capillary at a first location of the sample holder and to control capillary electrophoresis of the sample volume within the capillary at a second, different location of the sample holder.

10. The microsampling system according to claim 9, further comprising a graphical user interface configured to at least one of display or enable selection of a location of a sample volume on the sample holder, and wherein the at least one processor is caused to control injection of the sample volume from the at least one of displayed or selected location.

11. The microsampling system according to claim 1, wherein the robotic translation mechanism is a three-axis robotic translation mechanism configured to move the sample holder relative to the capillary along three perpendicular axes.

12. A method of microsampling, comprising:
moving a sample holder including at least a first sample volume within a sealed internal environment such that a capillary disposed within the sealed internal environment is operably positioned relative to the first sample volume;
pressurizing the sealed internal environment to inject at least a portion of the first sample volume into the capillary;
moving the sample holder such that the capillary, including the at least the portion of the first sample volume, is operably positioned relative to a background electrolyte electrically coupled to a voltage source; and
applying electrical energy from the voltage source to separate the at least the portion of the first sample volume within the capillary via capillary electrophoresis.

13. The method according to claim 12, further comprising outputting the at least the portion of the first sample volume to an electrospray ionization (ESI) interface of a mass spectrometer for mass spectrometry detection of the at least the portion of the first sample volume.

14. The method according to claim 13, further comprising:
moving the sample holder such that the capillary is operably positioned relative to a rinsing station; and
rinsing the capillary with a rinsing agent.

15. The method according to claim 14, wherein the sample holder further includes a second sample volume, and wherein the method further comprises:
moving the sample holder such that the capillary is operably positioned relative to the second sample volume;
pressurizing the sealed internal environment to inject at least a portion of the second sample volume into the capillary;
moving the sample holder such that the capillary, including the at least the portion of the second sample volume, is operably positioned relative to the background electrolyte electrically coupled to the voltage source; and
applying electrical energy from the voltage source to separate the at least the portion of the second sample volume within the capillary via capillary electrophoresis.

16. The method according to claim 12, wherein the moving the sample holder such that the capillary is operably positioned relative to the first sample volume, the pressurizing the sealed internal environment, the moving the sample holder such that the capillary is operably positioned relative to the background electrolyte, and the applying electrical energy are automatically performed under control of a processor executing instructions stored on a non-transitory computer readable storage medium.

17. The method according to claim 16, further comprising:
loading the sample holder into the housing; and
sealing the housing to define the sealed internal environment,
wherein the loading and the sealing are performed manually prior to automatically performing the moving the sample holder such that the capillary is operably positioned relative to the first sample volume, the pressurizing the sealed internal environment, the moving the sample holder such that the capillary is operably positioned relative to the background electrolyte, and the applying electrical energy.

18. The method according to claim 16, further comprising:
guiding at least one of the moving the sample holder such that the capillary is operably positioned relative to the first sample volume or the moving the sample holder such that the capillary is operably positioned relative to the background electrolyte using optical feedback provided by at least one camera.

19. The method according to claim 12, wherein pressurizing the sealed internal environment includes applying a pressure pulse of fluid into the sealed internal environment.

20. The method according to claim 12, further comprising:
receiving an input of a selection of a location of the first sample volume on the sample holder,
wherein the moving the sample holder such that the capillary is operably positioned relative to the first sample volume includes moving the sample holder such that the capillary is operably positioned at the selected location of the first sample volume.

21. A non-transitory computer-readable storage medium storing instructions that, when executed by at least one processor, cause the at least one processor to control:
movement of a sample holder including at least a first sample volume within a sealed internal environment such that a capillary disposed within the sealed internal environment is operably positioned relative to the first sample volume;
pressurization of the sealed internal environment to inject at least a portion of the first sample volume into the capillary;
movement of the sample holder such that the capillary, including the at least the portion of the first sample volume, is operably positioned relative to a background electrolyte electrically coupled to a voltage source; and
application of electrical energy from the voltage source to separate the at least the portion of the first sample volume within the capillary via capillary electrophoresis.
